(19) United States
(12) Patent Application Publication
(10) Pub. No.: US 2014/0244746 A1
(43) Pub. Date: Aug. 28, 2014

(54) Systems and Methods for Message Routing Using Link State Information

(71) Applicant: RED HAT, INC., Raleigh, NC (US)

(72) Inventors: Theodore Langston Ross, Littleton, MA (US); Andrew Michael Goldstein, Rockville, MD (US)

(73) Assignee: RED HAT, INC., Raleigh, NC (US)

(21) Appl. No.: 13/777,874

(22) Filed: Feb. 26, 2013

(51) Int. Cl. H04L 29/08

(52) U.S. Cl. CPC H04L 67/104
USPC 709/204

(57) ABSTRACT

Systems and methods for link state-based message routing in messaging systems. An example method, performed by a message broker, may comprise: receiving a topology update message from a second message broker; updating, in view of the topology update message, a data structure storing messaging bus topology information; receiving a message including an identifier of a destination message broker; determining, using the data structure storing messaging bus topology information, an identifier of a peer message broker corresponding to the destination message broker; and forwarding the message to the peer message broker over a messaging bus.

### TECHNICAL FIELD

The present disclosure is generally related to messaging systems, and is more specifically related to systems and methods for message routing using link state information.

### BACKGROUND

Messaging is a form of computer system communication based on exchange of messages between two or more computer systems over one or more message transport systems (e.g., interconnected networks). Messaging technologies provide a distributed abstraction layer between software applications running on the computer systems and the underlying message transport systems, thus making the software applications agnostic of the topology, protocols, and other implementation details related to the message transport systems, thus allowing integration of heterogeneous applications and platforms.

The distributed abstraction layer facilitating delivery of messages is often referred to as message-oriented middleware. Message-oriented middleware may include software and/or hardware components facilitating sending and receiving messages between computer systems.

### BRIEF DESCRIPTION OF THE DRAWINGS

The present disclosure is illustrated by way of examples, and not by way of limitation, and may be more fully understood with references to the following detailed description when considered in connection with the figures, in which:

FIG. 1 depicts a network-level diagram of one illustrative embodiment of a distributed messaging system in accordance with one or more aspects of the present disclosure;

FIG. 2 schematically illustrates a messaging bus including a plurality of message brokers, in accordance with one or more aspects of the present disclosure;

FIG. 3 depicts a flow diagram of a method for message routing in a messaging system, in accordance with one or more aspects of the present disclosure; and

FIG. 4 depicts a block diagram of an illustrative computer system operating in accordance with examples of the present disclosure.

### DETAILED DESCRIPTION

Described herein are methods and systems for link state-based message routing in messaging systems. “Messaging bus” herein shall refer to a distributed computer-based system facilitating message exchange between heterogeneous software applications running on one or more distributed computer systems which may be interconnected by one or more heterogeneous networks. A messaging bus may include shared infrastructure for delivering messages to recipients, data models (e.g., message schemas), and message delivery protocols. The shared infrastructure may include a plurality of message brokers. “Message broker” herein shall refer to a computer-based system for message routing and delivery.

A messaging bus may have one or more of the following attributes: local access points for messaging clients, distributed infrastructure, and redundancy of paths between message brokers. Local access points for messaging clients may relieve the clients from the necessity of having direct network access to a plurality of end-points within the messaging bus. The distributed architecture streamlines client deployment, since adding and/or removing messaging clients to the system involves only local configuration changes or no configuration changes at all. Redundancy of paths between message brokers allows achieving a reasonable level of reliability, since a failure of any one component or link between components may be remedied by using a different path to the destination

A messaging bus may rely upon the underlying transport system for inter-broker message delivery. One example of such a transport system may be an Internet Protocol (IP) network, in which a message delivery protocol (such as, for example, Advance Message Queuing Protocol(AMQP)) relies upon Transmission Control Protocol (TCP) or User Datagram Protocol (UDP) transport layer for message delivery. The underlying IP network may have a plurality of redundant paths between some endpoints to which message brokers are connected, and the IP layer is responsible for selecting one or more paths from the plurality of available paths for routing a TCP packet or a UDP datagram, thus effectively isolating the application layer (e.g., the messaging bus) from the implementation details of the underlying transport with respect to routing TCP packets and/or UDP datagrams.

Since a message broker within a messaging bus may be able to exchange messages with two or more peer message brokers, the application level path redundancy may also be achieved. Hence, efficient routing methods for routing messages between message brokers are needed. Message routing systems and methods described herein involve sharing link state information between a plurality of message brokers in a messaging bus. Various aspects of the above referenced methods and systems are described in details herein below by way of examples, rather than by way of limitation.

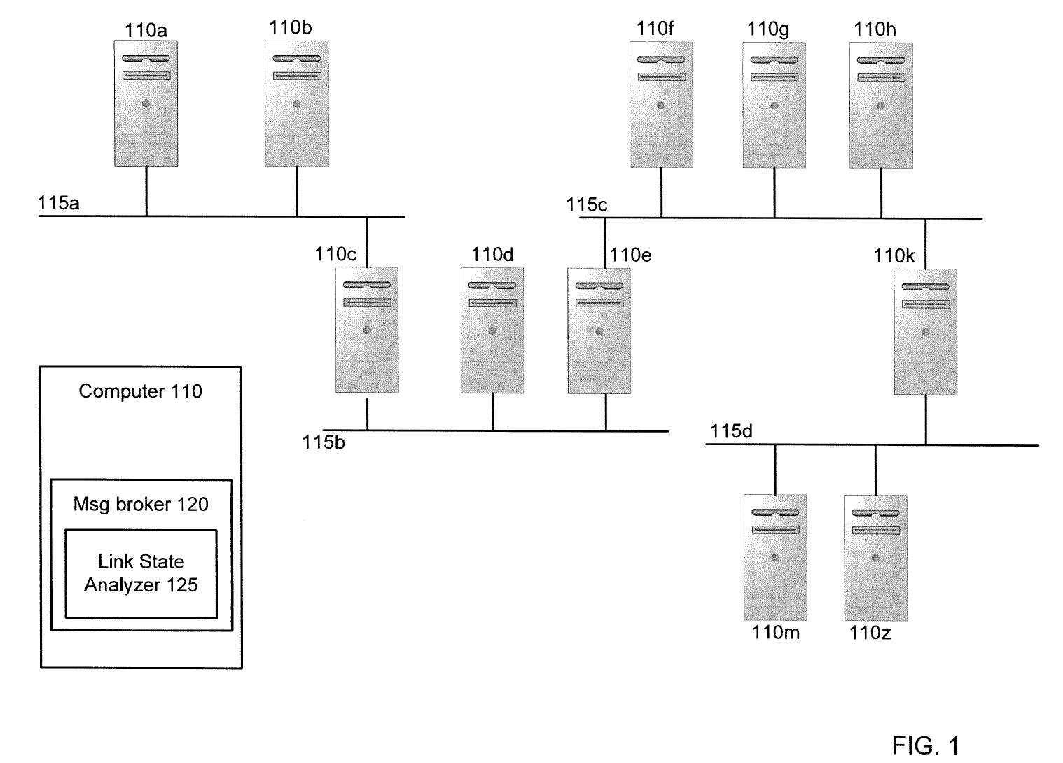

FIG. 1 depicts a network-level diagram of one illustrative embodiment of a distributed messaging system in accordance with one or more aspects of the present disclosure. A plurality of computers 110a-110z may be interconnected by a plurality of networks 115a-115z. A “computer” herein shall refer to an apparatus including a processor, a memory, and at least one input/output (I/O) interface. A computer may be represented, e.g., by a portable or desktop personal computer (PC), a server, a virtual machine running on a host computer system, or a smartphone. A “network” herein shall refer to a distributed communication system interconnecting two or more computers. A network may be represented, e.g., by a local area network (LAN), a wide area network (WAN), or a virtual private network (VPN).

Message broker components 120 may be executed by the computers 110a-110z. A message broker 120 may be locally accessible by one or more messaging clients (not shown in FIG. 1). A message broker may be in communication with one or more peer message brokers over a plurality of messaging links established over the plurality of networks 115a-115z. At the messaging bus level, a message broker may be capable of sending messages to a peer message broker directly, e.g., over a single messaging bus hop (notwithstanding the fact that at the underlying network level the message may be split into payloads of several network packets and/or routed via numerous network nodes), or via other message brokers. In a messaging system with path redundancy, an optimal path between two message brokers may be determined and employed for efficient message routing. In one example, a message broker component 120 may include a link state analyzer component 125 yielding an optimal path to a given message broker using the methods described in more details herein below.

In determining an optimal path, the objective function may be represented, e.g., by the number of hops (messaging links or message brokers) to be traversed along the path, cost of message delivery, estimated time of message delivery, or a combination of these and/or other criteria. Thus, depending on the objective function chosen, “optimal path” may refer, e.g., to the shortest path, the least cost path, or the fastest path. Hence, a reference to “optimal path” may be understood as a reference to “optimal path determined using the chosen objective function.”

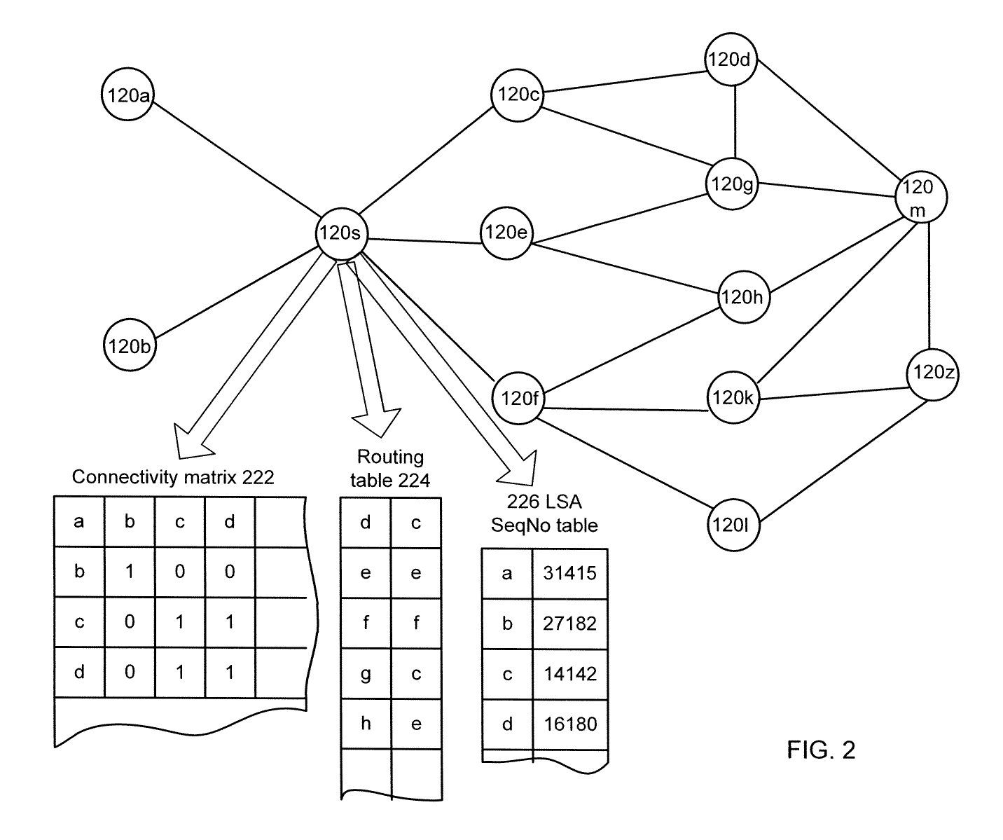

FIG. 2 schematically illustrates a messaging bus 100 including a plurality of message brokers 120a-120z, in accordance with one or more aspects of the present disclosure. In one example, multiple paths may exist between the source message broker 120s and the destination message broker 120d, while only one a subset comprising one or more paths of the multiple paths may be optimal.

In order to select the optimal path to the destination message broker 120d, the source message broker 120s may need the full topology information of the messaging bus 100. The latter may comprise link states of the message brokers 120 participating in the messaging bus, where “link state” refers to a list of peer message brokers in communication with a given message broker. Storing the full topology information by a message broker participating in a messaging bus, rather than retrieving it from a centralized location may provide a better overall system reliability by eliminating a single point of failure which the centralized location would represent.

Thus, in one example, a message broker participating in the messaging bus 100 may need to perform the following tasks: determining, based on locally stored system topology information, an optimal path, relative to a defined path optimization function, to a given destination message broker; determining own link status; informing peer message brokers about changes in its link status; and updating the system topology information based on topology update messages received from peer message brokers, as described in more details herein below.

In certain implementations, the message broker 120 may store the messaging bus topology information in a volatile or non-volatile memory. In one example, the messaging bus topology may be stored as a connectivity matrix 222, as schematically shown in FIG. 2, having a binary connectivity indicator at intersections of rows and columns corresponding to the message brokers participating in the messaging bus. Alternatively, the binary connectivity indicator may be substituted with a value of the objective function (e.g., time or cost of sending a message over the corresponding link). In another example, the messaging bus topology may be stored as a collection of link states (e.g., a collection of lists of peer message brokers in communication with a given message broker) for message brokers participating in the messaging bus 100.

Responsive to receiving, from a messaging client or from a peer message broker, a message to be delivered to a destination message broker, the message broker 120 may determine an optimal path to the destination message broker and forward the message to the next peer message broker on the path, which may coincide with the destination message broker if the latter is directly reachable by the message broker 120. In one example, the optimal path may be determined using Dijkstra's method of solving a shortest path problem.

In certain implementations, the message broker 120 may eliminate redundant calculations of optimal path by maintaining a routing table comprising optimal path information for a plurality of destinations. The routing table may be stored in volatile or non-volatile memory accessible by the message broker 120. In one example, as schematically shown in FIG. 2, the routing table 224 may include a plurality of entries, each entry mapping a destination message broker to the best next-hop peer message broker, which may be represented by the first message broker on the optimal path from the message broker 120 to the destination message broker, or the destination message broker (if the latter is directly reachable by the message broker 120). In one example, the message broker 120 may maintain two or more routing tables, each one compiled in view of a given objective function.

The message broker 120 may update the messaging bus topology information and/or the routing table responsive to detecting a change in own link state or responsive to receiving a topology update message from a peer message broker. To update the routing table, optimal paths to one or more destinations are re-calculated in view of the topology changes detected by the message broker 120 and/or reflected in one or more topology update messages received from peer message brokers. In certain implementations, topology update messages sent and received by message brokers participating in a messaging bus may include HELLO messages, link state advertisements (LSAs), link state requests (LSRs), and link state updates (LSUs).

The message broker 120s may send a HELLO message to one or more peer message brokers which are directly (i.e., over a single messaging bus hop) reachable by the message broker 120. The HELLO message may comprise a list of message brokers which are in bi-directional communication with the message broker 120s. In one example, the HELLO message may include a list of peer message brokers from which the message broker 120s has recently (within a defined period of time before the outgoing HELLO message transmission time) received a HELLO message. In the example of FIG. 2, the message broker 120s may receive, within a defined period of time, HELLO messages from peer message brokers 120a, 120c, 120e, and 120f, and then send a HELLO message containing the list {120a, 120c, 120e, 120f} to the peer message brokers 120a, 120b, 120c, 120e, and 120f.

Responsive to receiving, from a peer message broker, a HELLO message containing a link state list including an identifier of the receiving message broker, the latter may add the message broker which transmitted the HELLO message to its link state list, since a bi-directional connectivity between the two message brokers has been established. In the example of FIG. 2, responsive to receiving from the message broker 120b a HELLO message containing a link state list including the message broker 120s, the latter may add the message broker 120b to its link state list.

In certain embodiments, a message broker may send an LSA message to its peer message brokers. The LSA message may contain a sequence number which is incremented by the message originator if its own link state changes. Responsive to receiving the LSA message, the recipient message broker may forward it to its peer message brokers, thus broadcasting the LSA message over the messaging system 100. In the example of FIG. 2, the message broker 120a may transmit an LSA message to the message broker 120s, which may then forward it to message brokers 120c, 120e, and 120f.

Responsive to receiving an LSA message, the recipient message broker may determine whether the originator's link state has changed, by comparing the sequence number extracted from the received LSA message with a value extracted from a table 226 mapping message broker identifiers to the respective LSA sequence numbers. Should the two sequence numbers differ, the recipient message broker may transmit a LSR message to the LSA originator message broker.

Responsive to receiving an LSR message, the recipient message broker may respond to the LSR originator by an LSU message representing the current link state information of the LSU originator.

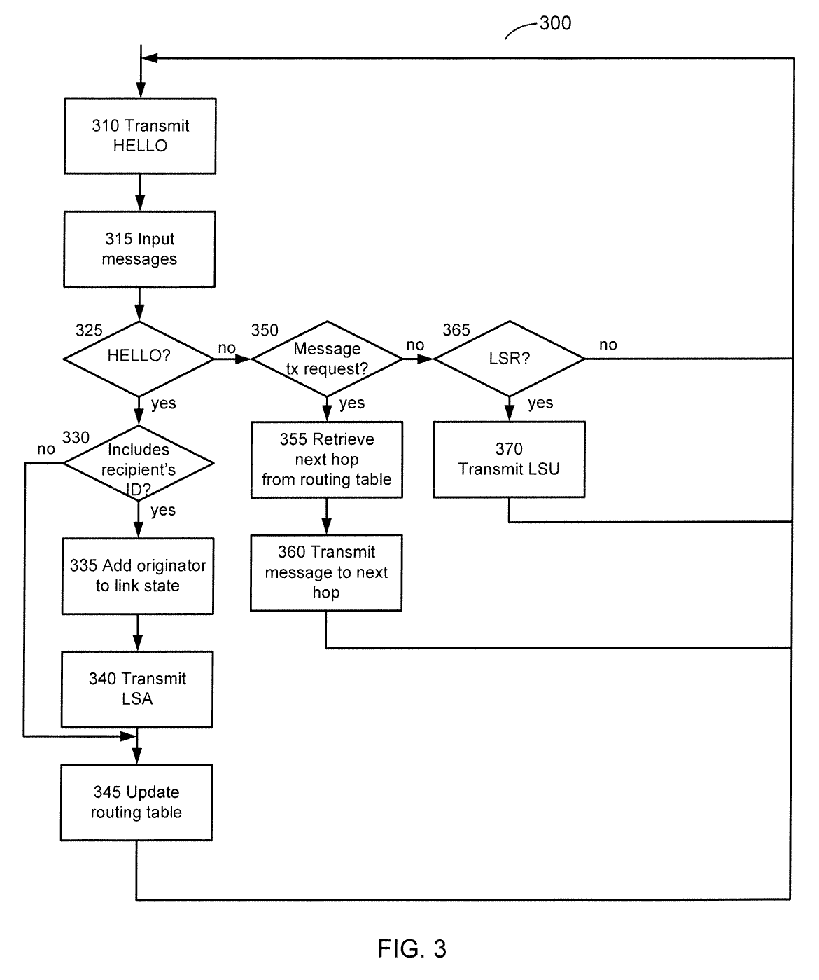

FIG. 3 depicts a flow diagram of one embodiment of a method 300 for message routing by a message broker using link state information. The method 300 may be performed by a message broker executing on a computer system that may comprise hardware (e.g., circuitry, dedicated logic, and/or programmable logic), software (e.g., instructions executable on a computer system to perform hardware simulation), or a combination thereof. The method 300 and/or each of its individual functions, routines, subroutines, or operations may be performed by one or more physical processors of the computer system executing the method. Two or more functions, routines, subroutines, or operations of the method 300 may be performed in parallel or in an order which may differ from the order described above.

At block 310, a first message broker executing by a computer system may transmit a topology update (HELLO) message to one or more peer message brokers which are directly reachable by the message broker which originated the HELLO message. The HELLO message may comprise a list of message brokers which are in bi-directional communication with the message broker which originated the message. In one example, the HELLO message may include a list of peer message brokers from which the message broker which originated the message has recently (within a defined period of time of the outgoing HELLO message transmission time) received a HELLO message.

Responsive to receiving, at block 315, a message from a peer message broker or from a messaging client, the first message broker may, at block 325, ascertain whether the received message is a HELLO message. If so, the processing may continue at block 330, otherwise, the method may branch to block 350.

Responsive to ascertaining, at block 330, that the incoming HELLO message comprises a link state list including an identifier of the first message broker, the latter may, at block 335, add to its link state list the message broker which originated the HELLO message. Otherwise, the processing may continue at block 345.

At block 340, the first message broker may increment a sequence number indicting a change in its link state list and transmit an LSA message to its peer message brokers.

At block 345, the first message broker may update a routing table to reflect the changes in the link state list contained in the received HELLO message, by re-calculating optimal paths to one or more destinations, as described in more details herein above. Upon updating the routing table, the method may loop back to step 310.

Responsive to ascertaining, at block 350, that the incoming message is a message transmission request originated by a messaging client, the first message broker may, at step 355, identify a peer message broker to which the message should be forwarded, by retrieving the best next hop identifier from the routing table, as described in more details herein above. At block 360, the first message broker may forward the message to the identified peer message broker, and the method may loop back to step 310.

Responsive to ascertaining, at block 365, that the incoming message is an LSR message originated by a peer message broker, the first message broker may, at step 370, transmit an LSU message to the originating message broker, as described in more details herein above. The method may then loop back to step 310.

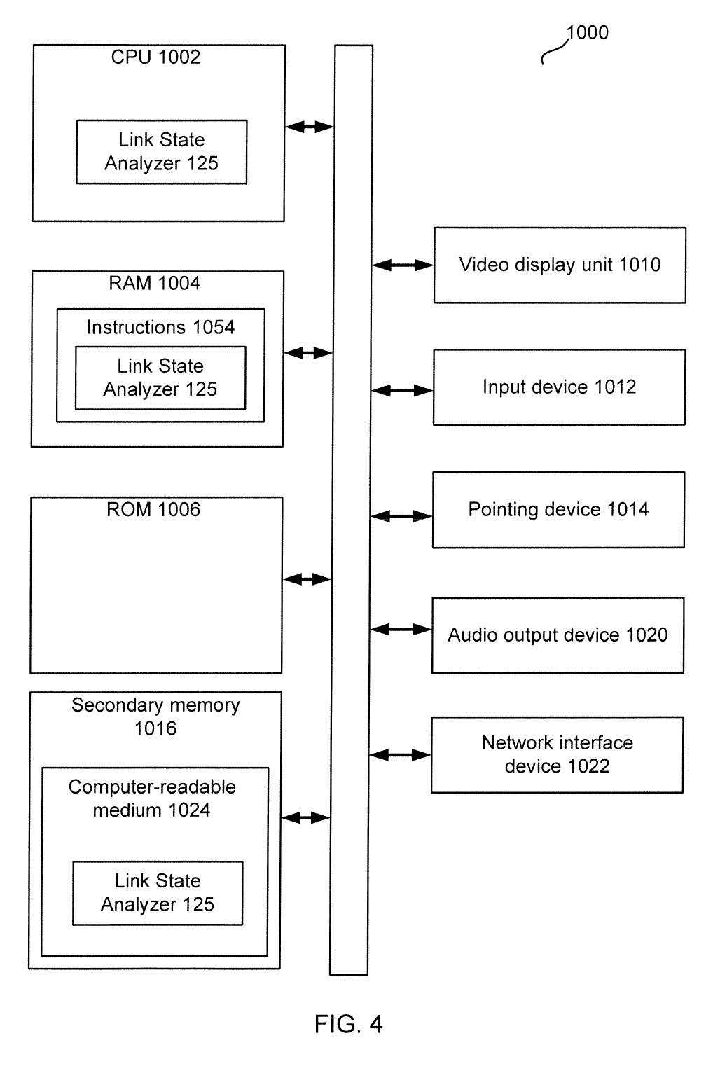

FIG. 4 depicts an example computer system 1000 within which a set of instructions, for causing the computer system to perform any one or more of the methods described herein, may be executed. In certain embodiments, computer system 1000 may correspond to one or more computer systems 110 of FIG. 1.

In certain embodiments, computer system 1000 may be connected (e.g., via a network, such as a Local Area Network (LAN), an intranet, an extranet, or the Internet) to other computer systems. Computer system 1000 may operate in the capacity of a server or a client computer in a client-server environment, or as a peer computer in a peer-to-peer or distributed network environment. Computer system 1000 may be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 1000 may include a physical processor 1002, a volatile memory 1004 (e.g., random access memory (RAM)), a non-volatile memory 1006 (e.g., read-only memory (ROM) or electrically-erasable programmable ROM (EEPROM)), and a secondary memory 1016 (e.g., a data storage device), which may communicate with each other via a bus 1008.

The processor 1002 may be provided by one or more physical processors such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

The computer system 1000 may further include a network interface device 1022. The computer system 1000 also may include a video display unit 1010 (e.g., an LCD), an alphanumeric input device 1012 (e.g., a keyboard), a pointing device 1014 (e.g., a mouse), and an audio output device 1020 (e.g., a speaker).

The secondary memory 1016 may include a non-transitory computer-readable storage medium 1024 on which may be stored instructions of the link state analyzer component 125. Instructions of the link state analyzer component 125 may also reside, completely or partially, within the main memory 1004 and/or within the processor 1002 during execution thereof by the computer system 1000, hence, the main memory 1004 and the processor 1002 may also constitute machine-readable storage media.

While the computer-readable storage medium 1024 is shown in the illustrative embodiment as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any non-transitory medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and software components, or only in software.

Unless specifically stated otherwise, terms such as “updating”, “identifying”, “determining”, “sending”, “assigning”, or the like, refer to actions and processes performed or implemented by computer systems that manipulate and transform data represented as physical (electronic) quantities within the computer system's registers and memories into other data similarly represented as physical quantities within the computer system memories or registers or other such information storage, transmission or display devices.

Embodiments described herein also relate to an apparatus for performing the methods described herein. This apparatus may be specially constructed for the required purposes, or it may comprise a general purpose computer system selectively programmed by a computer program stored in the computer system. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method functions, routines, subroutines, or operations. The required structure for a variety of these systems will appear as set forth in the description above.

The above description is intended to be illustrative, and not restrictive. Although the present disclosure has been described with references to specific illustrative examples and embodiments, it will be recognized that the present disclosure is not limited to the embodiments described. The scope of the disclosure should be determined with reference to the following claims, along with the full scope of equivalents to which the claims are entitled.

1. A method, comprising receiving, by a first message broker executing on a computer system, a topology update message from a second message broker;
updating, by the first message broker, in view of the topology update message, a data structure storing messaging bus topology information;
receiving, by the first message broker, a message including an identifier of a destination message broker;
determining, by the first message broker, using the data structure storing messaging bus topology information, an identifier of a peer message broker corresponding to the destination message broker; and
forwarding, by the first message broker, the message to the peer message broker over a messaging bus.

2. The method of claim 1, wherein the topology update message comprises a list of identifiers of message brokers in communication with a message broker which originated the topology update message.

3. The method of claim 1, wherein the second message broker and the peer message broker are represented by one message broker.

4. The method of claim 1, wherein the peer message broker resides on an optimal route from the first message broker to the destination message broker over the messaging bus.

5. The method of claim 1, wherein the data structure storing messaging bus topology information includes a plurality of mappings of destination message brokers to peer message brokers, each peer message broker being directly accessible by the first message broker over the messaging bus.

6. The method of claim 1, wherein the updating comprises calculating an optimal path from the first message broker to the destination message broker.

7. The method of claim 1, further comprising:
sending, by the first message broker, an outgoing topology update message including a list of identifiers of message brokers in communication with the first message broker.

8. The method of claim 1, further comprising:
updating, by the first message broker, a list of message brokers in communication with the first message broker;
incrementing, by the first message broker, a sequence number; and
transmitting, by the first message broker, an outgoing topology update message including the sequence number.

9. The method of claim 1, further comprising:
receiving, by the first message broker, a topology update request from the second message broker; and
transmitting, by the first message broker, an outgoing topology update message to the second message broker.

10. A computer-readable non-transitory storage medium comprising executable instructions that, when executed by a computer system, cause the computer system to:
receive, by a first message broker executing on a computer system, a topology update message from a second message broker;
update, in view of the topology update message, a data structure storing messaging bus topology information;
receive a message including an identifier of a destination message broker;
determine, using the data structure storing messaging bus topology information, an identifier of a peer message broker corresponding to the destination message broker; and
forward the message to the peer message broker over a messaging bus.

11. The computer-readable non-transitory storage medium of claim 10, wherein the topology update message comprises a list of identifiers of message brokers in communication with a message broker which originated the topology update message.

12. The computer-readable non-transitory storage medium of claim 10, wherein the peer message broker resides on an optimal route from the first message broker to the destination message broker over the messaging bus.

13. The computer-readable non-transitory storage medium of claim 10, wherein the data structure storing messaging bus topology information includes a plurality of mappings of destination message brokers to peer message brokers.

14. The computer-readable non-transitory storage medium of claim 10, further comprising executable instructions that cause the computer system to:
send an outgoing topology update message including a list of identifiers of message brokers in communication with the first message broker.

15. A system comprising:
a memory; and
one or more physical processors, coupled to the memory, to:
receive, by a first message broker executing on a computer system, a topology update message from a second message broker;
update, in view of the topology update message, a data structure storing messaging bus topology information;
receive a message including an identifier of a destination message broker;
determine, using the data structure storing messaging bus topology information, an identifier of a peer message broker corresponding to the destination message broker; and
forward the message to the peer message broker over a messaging bus.

16. The system of claim 15, wherein the topology update message comprises a list of identifiers of message brokers in communication with a message broker which originated the topology update message

17. The system of claim 15, wherein the peer message broker resides on an optimal route from the first message broker to the destination message broker over the messaging bus.

18. The system of claim 15, wherein the data structure storing messaging bus topology information includes a plurality of mappings of destination message brokers to peer message brokers.

19. The system of claim 15, wherein the one or more physical processors are further to:
update a list of message brokers in communication with the first message broker;
increment a sequence number; and
transmit an outgoing topology update message including the sequence number.

20. The system of claim 15, wherein the one or more physical processors are further to:
receive a topology update request from the second message broker; and
transmit an outgoing topology update message to the second message broker.
